(19) United States
(12) Patent Application Publication
(10) Pub. No.: US 2018/0186070 A1
(43) Pub. Date: Jul. 5, 2018

(54) METHOD FOR MANUFACTURING THREE-DIMENSIONAL SHAPE

(71) Applicant: FUTURECAST CO., LTD., Hwaseong-si Gyeonggi-do (KR)

(72) Inventors: Kwang-il YUN, Incheon (KR); Tae-yoon PARK, Seoul (KR)

(21) Appl. No.: 15/736,708

(22) PCT Filed: Jun. 14, 2016
(86) PCT No.: PCT/KR2016/006283

§ 371 Date: Dec. 14, 2017

(30) Foreign Application Priority Data
Jun. 15, 2015 (KR) 10-2015-0083864

(51) Int. Cl. B29C 64/165; B29C 64/188; B29C 64/321

(52) U.S. Cl. CPC B29C 64/165; B33Y 10/00; B29C 64/321; B29C 64/188

(57) ABSTRACT

Provided is a method of manufacturing a three-dimensional shape, which includes a first step in which unit blocks having a predetermined volume are stacked inside a forming mold and, among the stacked unit blocks, unit blocks constituting a three-dimensional shape to be manufactured are partially joined to each other to form a unit block-coupled body, a second step in which the forming mold is removed and unjoined unit blocks that are not included in the unit block-coupled body are removed, and a third step in which the unit block-coupled body is post-processed to form the three-dimensional shape.

### TECHNICAL FIELD

The present invention relates to a method of manufacturing a three-dimensional shape, and more particularly, to a method of manufacturing a three-dimensional shape in which unit block bodies having a predetermined shape and volume are partially joined and stacked to promptly form a unit block-coupled body and then the unit block-coupled body is post-processed to form a desired three-dimensional shape, thereby remarkably reducing time and energy required for manufacturing the three-dimensional shape.

### BACKGROUND ART

Conventionally, a method of directly cutting a mass of metal or wooden raw material to form a shape or a method of injecting a powder or molten raw material into a mold to form a shape has been used to manufacture a three-dimensional solid shape.

However, among the above pieces of related art, the former has a problem in that working time and precision in work (that is, dimension) significantly vary according to a worker's skillfulness, and the latter has a problem in that, because a separate mold has to be manufactured, a cost significantly increases when a work volume is small.

To solve such problems of the related art, a technology of manufacturing a three-dimensional shape using a 3D printer has been recently developed. Details of the 3D printer are disclose in [Literature 1] below.

The technology of manufacturing a three-dimensional shape using a 3D printer includes a method in which a three-dimensional shape is divided into plane units, and for each of the plane units, a liquid raw material is cured by ultraviolet (UV) radiation or a raw material of powder or filament form is melted using a heat source such as a laser to stack the raw material and form a shape.

Although the technology of manufacturing a three-dimensional shape using a 3D printer has an advantage in that a driving unit capable of three-axis movement moves according to computational modeling data of a three-dimensional shape and automatically forms the shape, because the shape is formed by repeatedly printing dot units or surface units, there is a problem in that excessive time and energy are required for manufacturing the shape when the three-dimensional model to be manufactured is a large structure used in a vehicle, a ship, or the like or a house.

[Literature 1] Korean Patent Registration No. 1,451,794 (published on Oct. 16, 2014)

### DISCLOSURE

### Technical Problem

The present invention has been devised to solve the above-described problem of the related art, and it is an objective of the present invention to provide a method of manufacturing a three-dimensional shape in which unit block bodies having a predetermined shape and volume are partially joined and stacked to promptly form a unit block-coupled body and then the unit block-coupled body is post-processed to form a desired three-dimensional shape, thereby remarkably reducing time and energy required for forming the three-dimensional shape.

### Technical Solution

To achieve the above objective, a method of manufacturing a three-dimensional shape according to the present invention includes a first step in which unit blocks having a predetermined volume are stacked inside a forming mold and, among the stacked unit blocks, unit blocks constituting a three-dimensional shape to be manufactured are partially joined to each other to form a unit block-coupled body, a second step in which the forming mold is removed and unjoined unit blocks that are not included in the unit block-coupled body are removed, and a third step in which the unit block-coupled body is post-processed to form the three-dimensional shape.

The unit blocks may be formed in at least one of a spherical shape or a polyhedral shape and have different volumes, and in the first step, at least one of the shape and the volume of the stacked unit blocks may be changed according to a position of the three-dimensional shape.

In the first step, the joining of the unit blocks may be performed by partially heating and melting at least one site of contact areas between neighboring unit blocks or applying an adhesive thereto.

In the first step, the unit block-coupled body may be formed to have an outer shape that is larger than the three-dimensional shape, and the post-processing in the third step may include mechanically processing the unit block-coupled body.

In the first step, the unit block-coupled body may be formed to have an outer shape that is smaller than the three-dimensional shape, and the post-processing in the third step may include applying a finishing material on a surface of the unit block-coupled body.

The post-processing in the third step may include a clearance removing step in which a clearance included in the unit block-coupled body is removed.

The clearance removing step may include heating and melting unit blocks around a site at which a clearance is formed to fill the clearance or injecting an adhesive filler or a molten liquid formed of the unit blocks into the clearance to fill the clearance.

### Advantageous Effects

As described above, in the method of manufacturing a three-dimensional shape according to the present invention, because unit block bodies having a predetermined volume are partially joined in a temporarily assembled form to promptly form a unit block-coupled body and then the unit block-coupled body is post-processed to form a desired three-dimensional shape, there is an advantage in that time and energy required for manufacturing a three-dimensional shape are remarkably reduced in comparison to a method of forming a three-dimensional shape using a 3D printer according to the related art in which a raw material is cured or melted in dot units or surface units to form a shape.

### DESCRIPTION OF DRAWINGS

FIG. 1 is a view illustrating a three-dimensional shape to be manufactured using a method of manufacturing a three-dimensional shape according to an embodiment of the present invention.

FIG. 2 is a view for describing a method of manufacturing the shape of FIG. 1 using the method of manufacturing a three-dimensional shape according to the embodiment of the present invention.

FIG. 3 is a view for sequentially describing the method of manufacturing the shape of FIG. 1 according to the embodiment of the present invention with respect to a cross-section taken along line A-A of FIG. 2.

FIG. 4 is a flowchart for describing the method of manufacturing a three-dimensional shape according to the embodiment of the present invention.

FIG. 5 is a view illustrating a schematic configuration of a device for manufacturing a three-dimensional shape according to the embodiment of the present invention.

FIG. 6 is a view illustrating a modified example of a raw material feeder used in the device of FIG. 5.

### MODES OF THE INVENTION

Hereinafter, exemplary embodiments of the present invention will be described in detail using the accompanying drawings.

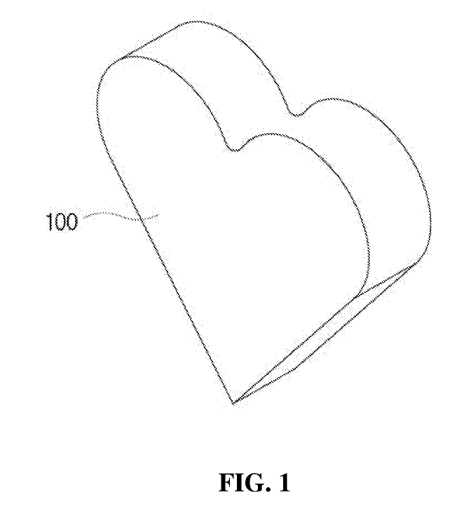

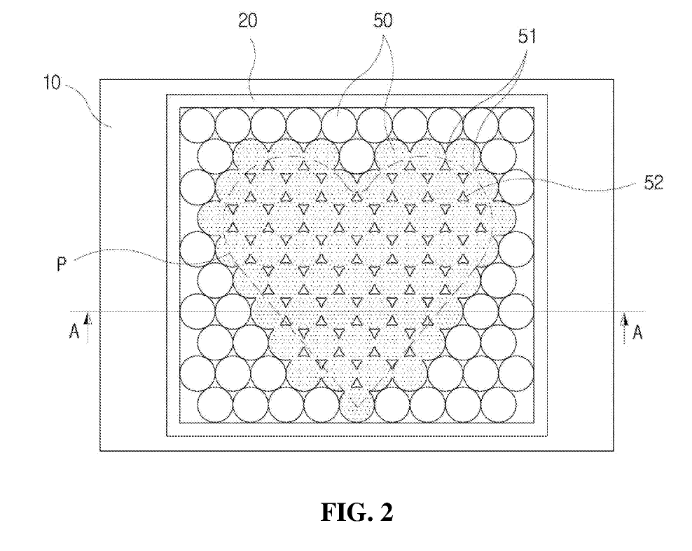

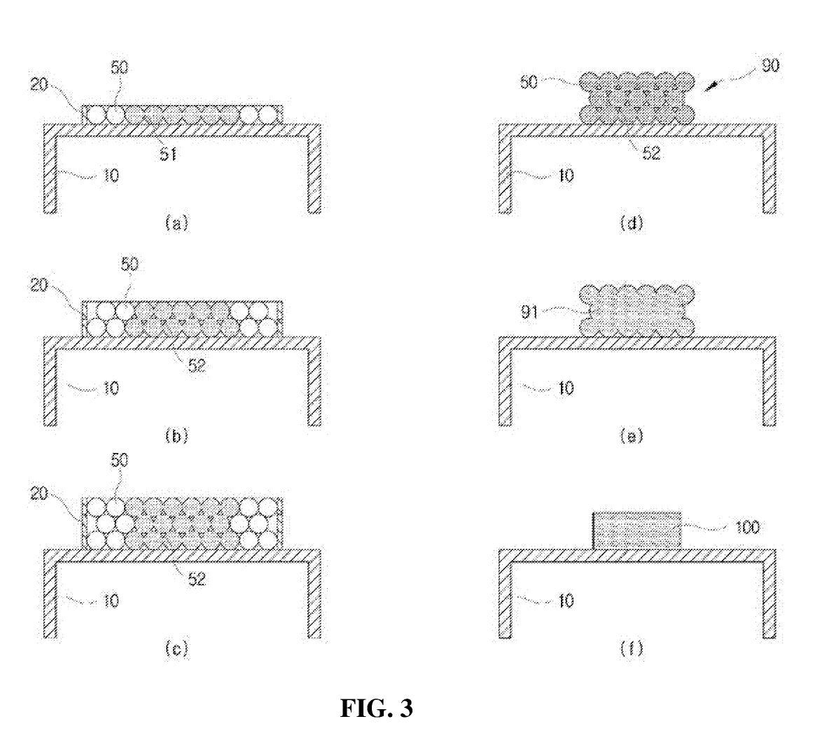

FIG. 1 is a view illustrating a three-dimensional shape to be manufactured using a method of manufacturing a three-dimensional shape according to an embodiment of the present invention, FIG. 2 is a view for describing a method of manufacturing the shape of FIG. 1 using the method of manufacturing a three-dimensional shape according to the embodiment of the present invention, and FIG. 3 is a view for sequentially describing the method of manufacturing the shape of FIG. 1 according to the embodiment of the present invention with respect to a cross-section taken along line A-A of FIG. 2.

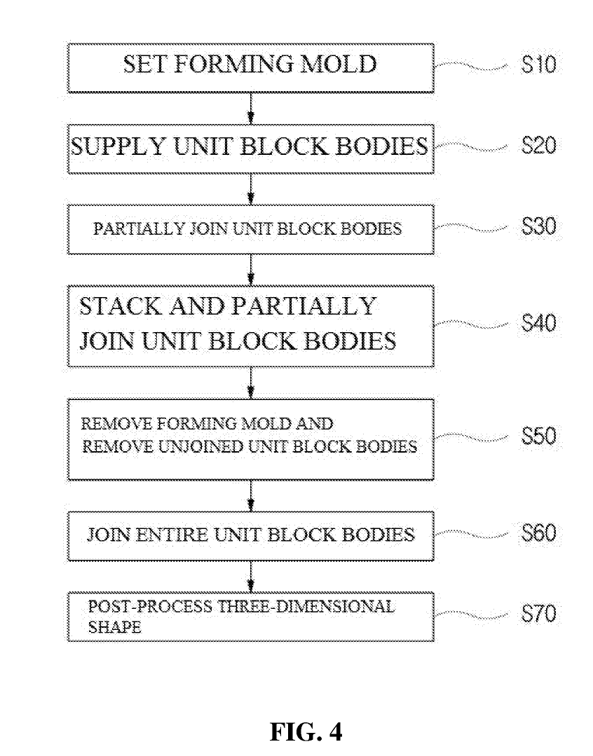

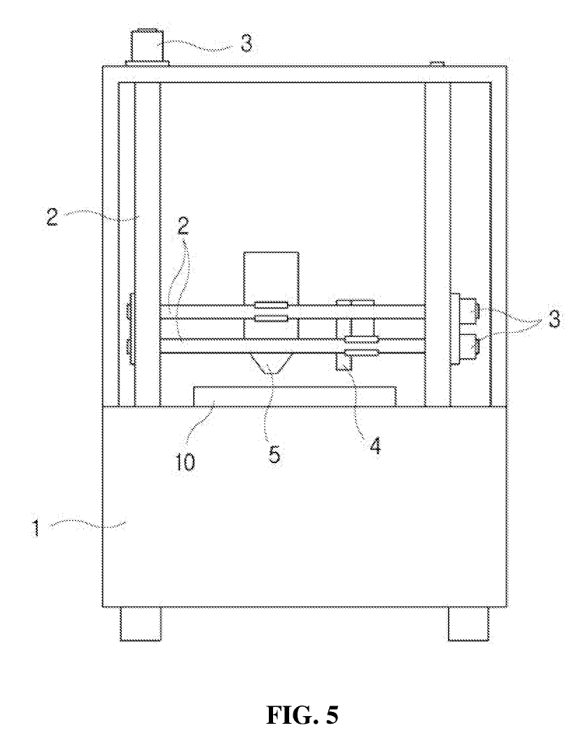

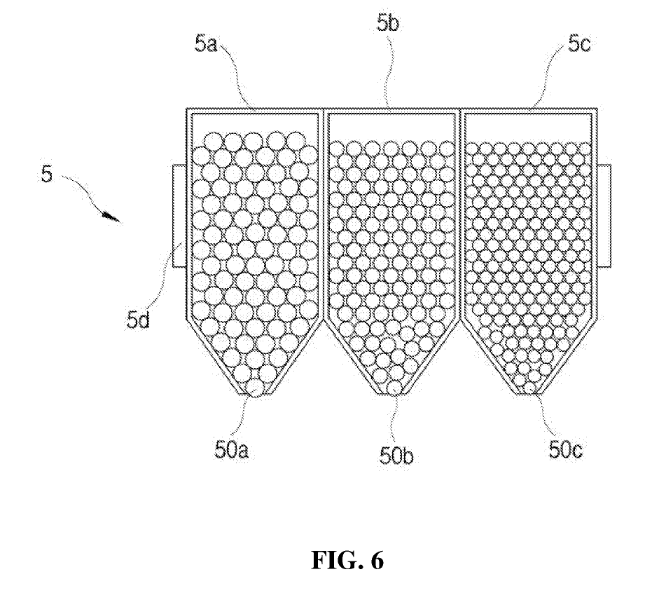

FIG. 4 is a flowchart for describing the method of manufacturing a three-dimensional shape according to the embodiment of the present invention, FIG. 5 is a view illustrating a schematic configuration of a device for manufacturing a three-dimensional shape according to the embodiment of the present invention, and FIG. 6 is a view illustrating a modified example of a raw material feeder used in the device of FIG. 5.

First, in the present embodiment, for convenience of description, a case in which a sample 100 in a heart form illustrated in FIG. 1 is manufactured using the method of manufacturing a three-dimensional shape according to the present invention will be described as an example.

In the method of manufacturing a three-dimensional shape according to the present invention, first, a forming mold 20 for forming the sample 100 is set on a worktable 10 (S10). In this case, as will be described below, the forming mold 20 serves as a shielding member or a boundary member that confines and contains supplied unit block bodies 50 therein.

Here, although the forming mold may be set using a separate process or device (for example, a lifting/lowering device perpendicular to an upper surface of the worktable), depending on a form of a three-dimensional shape to be manufactured, the forming mold may also be set using a method in which unit block bodies 50 disposed at a boundary portion are partially joined or entirely joined in a process in which Step S20 and Step S30, which will be described below, are performed using a device for manufacturing a three-dimensional shape which will be described as an example in the present embodiment.

That is, for example, when a three-dimensional shape to be manufactured is the sample 100 of the present embodiment, although the forming mold 20 may be set in the shape of a quadrangular mold as illustrated in FIG. 2 using a separate process or device, the unit block bodies 50 disposed at the outermost portion among the unit block bodies (marked by hatching) that constitute the sample 100 may be joined first in each stacking step for the joined unit block bodies 50 to serve as the forming mold 20 as necessary.

Here, when the forming mold 20 is set using the latter method, Step S50 may be omitted from a process, which will be described below.

When Step S10 is completed, the unit block bodies 50 having a predetermined volume are supplied to an inside of the forming mold, and the unit block bodies 50 are arranged in a planar form as illustrated in FIG. 3(a) along a boundary formed by the forming mold 20 on a bottom surface of the worktable (S20).

Here, the unit block bodies 50 may be formed of various materials with which the sample 100 is desired to be manufactured such as metal, synthetic resin, chocolate, wood, cement, brick, and clay.

Although a case in which the unit block bodies 50 are formed in a spherical shape will be described as an example for convenience of description in the present embodiment, the present invention is not limited thereto, and the unit block bodies 50 may also be formed in a polyhedral shape such as a tetrahedral shape, a pentahedral shape, and a hexahedral shape as necessary.

When Step S20 is completed, the unit block bodies 50 constituting the shape of the sample 100 among the unit block bodies 50 arranged inside the forming mold 20 are partially jointed to each other (S30).

That is, in Step S30, as illustrated in FIG. 2 and FIG. 3(a), neighboring unit block bodies 50 of the unit block bodies 50 included within a virtual outline P of the sample 100 marked with a dotted line and the unit block bodies 50 that cross the outline P (these unit block bodies are distinguished by hatching in FIGS. 2 and 3) among the unit block bodies 50 contained in the forming mold 20 are partially joined to each other.

In this case, the joining of the unit block bodies 50 is performed by partially joining at least one site of contact areas (or contact portions) between the neighboring unit block bodies 50.

Here, in the present invention, “partially joining” the unit block bodies refer to joining in which a clearance is formed between at least some of the unit block bodies of the neighboring unit block bodies when the unit block bodies are stacked to form a unit block-coupled body, which will be described below.

Depending on the material of the unit block bodies 50, the joining of the unit block bodies 50 may be preferably performed using a heating-and-melting joining method using a heating source such as an electronic beam and laser (for example, when the unit block bodies 50 are formed of a metal material, synthetic resin, or chocolate) or using a method of applying an adhesive (for example, when the unit block bodies 50 are formed of wood).

Depending on the material of the unit block bodies 50, a chemical adhesive such as mortar, putty, clay, cement, epoxy, and hot melt or a natural adhesive such as glue may be used as the adhesive.

In the present embodiment, for convenience of description, a case in which the unit block bodies 50 are formed of a metal material, and the heating-and-melting joining method using laser melting is used as the joining method will be described as an example.

The neighboring unit block bodies 50 are combined in a temporarily assembled (or temporarily combined) form by partially joining portions 51 due to the partially joining process in Step S30. Various forms of clearances 52 are formed between the partially joining portions 51 depending on the shape of the unit block bodies 50 and a contact state therebetween.

In Step S30, when the partially joining the unit block bodies 50, which are objects to be joined, is completed on a single plane, the unit block bodies 50 are resupplied and stacked thereon as illustrated in FIG. 3(b) and FIG. 3(c) to repeat the process of partially joining the unit block bodies 50 constituting the shape of the sample 100 to each other (S40).

In this case, the height of the forming mold 20 is preferably increased in stages depending on a stacking step of the unit block bodies 50.

When the unit block bodies 50 are stacked, the unit block bodies 50 that neighbor each other in a vertical direction as well as the unit block bodies 50 that neighbor each other on the same plane of the unit block bodies 50 constituting the shape of the sample 100 are partially joined to each other through at least one site of contact areas therebetween.

Although a case in which, in the stacking process, the unit block bodies 50 are stacked in a vertical zigzag pattern such that upper unit block bodies 50 are disposed on the clearances 52 of lower unit block bodies 50 is described as an example in the present embodiment, the present invention is not limited thereto, and the unit block bodies 50 may also be stacked such that centers of upper and lower unit block bodies 50 neighboring each other are arranged on a vertical line as necessary.

Step S10 to Step S40 described above are performed using computational modeling data including shape information (or coordinate information) of the sample 100 as cases in which a general computer-aided design (CAD)/computer-aided manufacturing (CAM) system or a 3D printer is used. The modeling data may be obtained using any one of known programs for modeling a three-dimensional shape.

When Step S40 is performed for a sufficient number of times for obtaining the shape of the sample 100 to be manufactured, a unit block-coupled body 90 in which the unit block bodies 50 constituting the shape of the sample 100 are partially joined to each other in vertical and horizontal directions and form a single mass is formed inside the forming mold 20.

Here, as will be described below, the unit block-coupled body 90 is post-processed to obtain the sample 100 having a desired form. The post-processing may be performed by mechanically processing the unit block-coupled body 90 (or an outer surface thereof) when a surface of the sample 100 requires precise dimension and smoothness and may be performed by applying a finishing material on the outer surface of the unit block-coupled body 90 when the surface of the sample 100 does not require precise dimension and smoothness.

When the post-processing is performed by mechanically processing the unit block-coupled body 90, the unit block-coupled body 90 is preferably formed to have a larger size than that of the sample 100 in consideration of a processing tolerance, and when the post-processing is performed by applying a finishing material on the outer surface of the unit block-coupled body 90, the unit block-coupled body 90 is preferably formed to have a size equal to or smaller than that of the sample 100.

When the unit block-coupled body 90 is mechanically processed, the above-described task of applying a finishing material may be further performed as necessary.

A liquid or paste adhesive filler (including an adhesive, a groove-filling material such as putty, a coating material such as paint and varnish, and a binder) or a molten liquid formed of the unit block bodies 50 may be used as the finishing material.

In the present embodiment, for convenience of description, a case in which the post-processing is performed by mechanically processing the outer surface of the unit block-coupled body 90 will be described as an example.

When Step S40 is completed, the forming mold 20 and unjoined unit block bodies 50, which are not joined to other unit block bodies 50, are removed from the worktable 10 to obtain the above-described unit block-coupled body 90 (S50). Due to the above-described reason, the unit block-coupled body 90 has the form in which the clearances 52 are formed in the vertical and horizontal directions between the partially joining portions 51 of the unit block bodies 50.

When Step S50 is completed, by removing the clearances 52, a firm non-clearance unit block-coupled body 91 in the form in which the neighboring unit block bodies 50 are entirely completely joined to each other is obtained (S60).

Here, the clearance removing step may be performed by entirely or partially heating and melting the unit block bodies 50 around sites at which the clearances 52 are formed to fill the clearances or injecting a liquid or paste adhesive filler or a molten liquid formed of the unit block bodies 50 into the clearances 52 to fill the clearances 52.

For example, the unit block bodies 50 may be heated and melted or a molten liquid formed of the same material as that of the unit block bodies 50 may be injected into the clearances 52 to remove the clearances 52 when the unit block bodies 50 are formed of metal, synthetic resin, or chocolate, and a liquid or paste adhesive may be injected into the clearances 52 to remove the clearances 52 when the unit block bodies 50 are formed of wood.

When the non-clearance unit block-coupled body 91 is obtained through Step S60, the non-clearance unit block-coupled body 91 is processed using a general mechanical processing device such as a machining center and computer numerical control (CNC) machine to manufacture the desired three-dimensional sample 100 (S70).

Although a case in which Step S60 is performed as the post-processing for removing the clearances 52 after the unit block-coupled body 90 is obtained is described as an example in the present embodiment, the present invention is not limited thereto, and Step S60 may be omitted as necessary when the unit block bodies 50 forming the unit block-coupled body 90 are sufficiently firmly coupled such that the unit block bodies 50 may be mechanically processed by being partially joined to each other.

Although a case in which both Step S60, in which post-processing is performed to remove the clearances 52, and Step S70, in which post-processing is performed on the outer surface of the unit block-coupled body 90, are performed is described as an example in the present embodiment, any one of Step S60 and Step S70 may be selectively performed or the above-described step of applying a finishing material may be further performed after Step S60 and Step 70 are performed as necessary.

However, when only Step S60 is performed, it is more preferable that the unit block-coupled body 90 be formed to have an outer size that is substantially the same as that of the sample 100.

By such a configuration, in the method of manufacturing a three-dimensional shape according to the present invention, because the unit block bodies 50 having a predetermined volume are partially joined in a temporarily assembled form to promptly form the unit block-coupled body 90 and then the unit block-coupled body 90 is post-processed to form a desired three-dimensional sample 100, there is an advantage in that time and energy required for manufacturing a three-dimensional shape are remarkably reduced in comparison to a method of forming a three-dimensional shape using a 3D printer according to the related art in which a raw material is cured or melted in dot units or surface units to form a shape.

An example of a schematic configuration of a device for manufacturing a three-dimensional shape to which the method of manufacturing a three-dimensional shape according to the present invention is applied is illustrated in FIG. 5.

The device for manufacturing a three-dimensional shape includes a transfer shaft 2 configured to transfer a raw material feeder 5 and a laser melting device 4 in three-axis directions of the X-, Y-, and Z-axis and a transfer motor 3 configured to transfer the raw material feeder 5 and the laser melting device 4 through the transfer shaft 2, at an upper portion of a main body 1 at which the worktable 10 is formed.

Here, because configurations of the three-axis transfer shaft 2, the transfer motor 3, and the laser melting device 4 are known technologies, detailed descriptions thereof will be omitted. The raw material feeder 5 is configured to move through the transfer shaft 2 while the unit block bodies 50 are contained therein and supply the unit block bodies 50 to required positions such as a nozzle.

Although a case in which the unit block bodies 50 are formed to have the same volume (that is, size) is described as an example in the present embodiment, the present invention is not limited thereto, and the unit block bodies 50 may have different volumes as necessary.

That is, for example, the raw material feeder 5 may include a first feeder 5a configured to supply unit block bodies 50a having a first volume, a second feeder 5b configured to supply unit block bodies 50b having a second volume, and a third feeder 5c configured to supply unit block bodies 50c having a third volume. In this case, the feeders 5a, 5b, and 5c may be formed into a single assembly by a binding device 5d.

The shape of the unit block bodies 50 is not limited to a spherical shape as in the present embodiment, and the unit block bodies 50 may have various shapes including a spherical shape and various polyhedral shapes with respect to a specific size (or for each size) as necessary.

When the raw material feeder 5 is configured to supply the unit block bodies 50 having various sizes and/or shapes as described above, because the shape and/or volume (that is, size) of the unit block bodies 50 being stacked may be changed as necessary, changes in a partial shape or thickness of the three-dimensional sample 100 may be flexibly dealt with, and a workload during post-processing may be significantly reduced.

Although a case in which the three-dimensional shape is a heart-shaped sample is described as an example in the present embodiment, a “three-dimensional shape” in the detailed description and the claims of the present invention is a concept that encompasses various three-dimensional shapes including shapes of a house, a building, a tower, a ship, a vehicle, and a structure used therein.

Although a case in which the forming mold 20 is used is described as an example in the present embodiment, the present invention is not limited thereto, and the use of the forming mold 20 may be omitted as necessary (for example, in a case of a large structure such as a house).

### INDUSTRIAL APPLICABILITY

The present invention can provide a method of manufacturing a three-dimensional shape capable of significantly reducing time and energy required for forming a three-dimensional shape and can be used in manufacturing a large structure such as a vehicle and a ship as well as a small structure, thereby being highly industrially applicable.

1. A method of manufacturing a three-dimensional shape, the method comprising:
a first step in which unit blocks having a predetermined volume are stacked inside a forming mold and, among the stacked unit blocks, unit blocks constituting a three-dimensional shape to be manufactured are partially joined to each other to form a unit block-coupled body;
a second step in which the forming mold is removed and unjoined unit blocks that are not included in the unit block-coupled body are removed; and
a third step in which the unit block-coupled body is post-processed to form the three-dimensional shape.

2. The method of claim 1, wherein:
the unit blocks are formed in at least one of a spherical shape or a polyhedral shape and have different volumes; and
in the first step, at least one of the shape and the volume of the stacked unit blocks is changed according to a position of the three-dimensional shape.

3. The method of claim 1, wherein, in the first step, the joining of the unit blocks is performed by partially heating and melting at least one site of contact areas between neighboring unit blocks or applying an adhesive thereto.

4. The method of claim 1, wherein:
in the first step, the unit block-coupled body is formed to have an outer shape that is larger than the three-dimensional shape; and
the post-processing in the third step includes mechanically processing the unit block-coupled body.

5. The method of claim 1, wherein:
in the first step, the unit block-coupled body is formed to have an outer shape that is smaller than the three-dimensional shape; and
the post-processing in the third step includes applying a finishing material on a surface of the unit block-coupled body.

6. The method of claim 1, wherein the post-processing in the third step includes a clearance removing step in which a clearance included in the unit block-coupled body is removed.

7. The method of claim 6, wherein the clearance removing step includes heating and melting unit blocks around a site at which a clearance is formed to fill the clearance or injecting an adhesive filler or a molten liquid formed of the unit blocks into the clearance to fill the clearance.

8. A method of manufacturing a three-dimensional shape, the method comprising:
a first step in which unit blocks having a predetermined volume are stacked to form a three-dimensional shape to be manufactured, and the stacked unit blocks are partially joined to each other to form a unit block-coupled body; and
a second step in which the unit block-coupled body is post-processed to form the three-dimensional shape,
wherein the post-processing in the second step includes at least one of a process of removing a clearance included in the unit block-coupled body, a process of mechanically post-processing the unit block-coupled body, and a process of applying a finishing material on an outer surface of the unit block-coupled body.

9. A method of manufacturing a three-dimensional shape, the method comprising:
a first step in which unit blocks having a predetermined volume are stacked, and, among the stacked unit blocks, unit blocks constituting a three-dimensional shape to be manufactured are partially joined to each other to form a unit block-coupled body; and
a second step in which unjoined unit blocks that are not included in the unit block-coupled body are removed.

10. The method of claim 5, wherein the post-processing in the third step includes a clearance removing step in which a clearance included in the unit block-coupled body is removed.
